(19) United States
(12) Patent Application Publication
(10) Pub. No.: US 2016/0054252 A1
(43) Pub. Date: Feb. 25, 2016

(54) Electrochemical Biosensor

(71) Applicant: Samsung Electronics Co., Ltd., Suwon-si (KR)

(72) Inventors: Seong-je CHO, Suwon-si (KR); Chul-ho CHO, Seongnam-si (KR); Jae-hong KIM, Incheon (KR); Su-ho LEE, Suwon-si (KR); Sun-tae JUNG, Yongin-si (KR); Jae-geol CHO, Yongin-si (KR); Kwang-bok KIM, Incheon (KR)

(21) Appl. No.: 14/834,093

(22) Filed: Aug. 24, 2015

(30) Foreign Application Priority Data
Aug. 22, 2014 (KR) 10-2014-0109960

(51) Int. Cl. G01N 27/27; G01N 27/327

(52) U.S. Cl. CPC G01N 27/27; G01N 27/3272; G01N 27/3273

(57) ABSTRACT

Provided is a biosensor having i) sufficient sensitivity allowing quantitative detection of a low concentration of an analyte; and ii) excellent selectivity allowing selective distinction of the presence of an analyte.

### RELATED APPLICATION(S)

This application claims the benefit of Korean Patent Application No. 10-2014-0109960, filed on Aug. 22, 2014, in the Korean Intellectual Property Office, the disclosure of which is incorporated herein in its entirety by reference.

### BACKGROUND

The present disclosure relates to a biosensor, and more particularly, to an electrochemical biosensor.

Biosensors are analytical sensors measuring a concentration or presence of a biological analyte. Examples of the biological analyte include glucose, cholesterol, lactate, creatinine, protein, peroxide, alcohol, amino acid, glutamic-pyruvic transaminase (GPT), and glutamic-oxaloacetic transaminase (GOT). Electrochemical biosensors detect flow, for example, current, or presence, for example, voltage, of electrons generated by electrochemical oxidation or reduction of an analyte.

A blood glucose sensor is an example of a biosensor. A blood glucose sensor typically includes a detecting reagent layer including glucose oxidase (GOx) or glucose dehydrase. When a drop of blood is collected on a detecting reagent layer, glucose oxidase selectively oxidizes glucose in the blood. A blood glucose sensor measures the intensity of the oxidizing current that occurs in such oxidation process so as to determine the glucose concentration in the blood.

If repeated glucose measurements are required, the measurement subject may suffer from pain due to repetitive blood sampling. Accordingly, a noninvasive glucose sensor has been developed, because the noninvasive glucose sensor does not require blood sampling. For example, a noninvasive glucose sensor capable of measuring the glucose concentration in the body fluid (e.g., sweat) secreted from the body of the measurement subject may be considered. Because glucose concentration is generally very low in body fluids, a noninvasive glucose sensor is required to have a relatively high sensitivity.

Electrochemical biosensors may be classified into an enzymatic sensor including a detecting reagent layer including an enzyme or a non-enzymatic sensor not including such a detecting reagent layer. An enzymatic sensor may have excellent selectivity with regards to glucose. However, an enzymatic sensor may not be able to exhibit sufficient sensitivity to quantitatively detect a low glucose concentration. On the other hand, a non-enzymatic sensor may be able to exhibit sufficient sensitivity to quantitatively detect a low glucose concentration. However, a non-enzymatic sensor may have poor selectivity with regards to glucose.

In order to improve the selectivity of a non-enzymatic sensor, attempts have been made to coat an electrode of the non-enzymatic sensor with a functional film. The functional film is intended to prevent a non-analyte from contacting an operation electrode. The functional film, for example, may be polyvinylidenefluoride (PVDF), chitosan, polyurethane, Nafion, polyethyleneimine (PEI), polyethyleneglycol, or a combination thereof. The functional film may prevent a number of non-analytes having a molecular weight greater than those of glucose and fructose from contacting an operation electrode. However, fructose has the same molecular weight, similar structure, and similar features with glucose. Thus, even with the functional film, it is difficult to eliminate signals of fructose. Therefore, still a non-enzymatic sensor may not have good selectivity with regards to glucose.

Therefore, there is a need of a biosensor having i) sufficient sensitivity allowing quantitative detection of a low concentration of an analyte; and ii) excellent selectivity allowing the presence of an analyte to be selectively distinguished.

### SUMMARY

Provided is a biosensor having i) sufficient sensitivity allowing quantitative detection of a low concentration of an analyte; and ii) excellent selectivity allowing selective distinction of the presence of an analyte.

Additional aspects will be set forth in part in the description which follows and, in part, will be apparent from the description, or may be learned by practice of the presented exemplary embodiments.

An embodiment of a biosensor according to an aspect of the present disclosure includes a first sensor including a first operation electrode and a first counter electrode that is spaced apart from the first operation electrode; a second sensor including a second operation electrode and a second counter electrode that is spaced apart from the second operation electrode, wherein a surface of the second operation electrode is coated with a detecting reagent layer including an enzyme; and a controller receives a first detect signal from the first sensor and a second detect signal from the second sensor, wherein the controller outputs a quantitative analysis value corresponding to the first detect signal and a qualitative analysis value corresponding to the second detect signal.

### BRIEF DESCRIPTION OF THE DRAWINGS

These and/or other aspects will become apparent and more readily appreciated from the following description of the exemplary embodiments, taken in conjunction with the accompanying drawings in which:

FIG. 1 is a diagram schematically illustrating an embodiment of a biosensor according to the present disclosure.

### DETAILED DESCRIPTION

Reference will now be made in detail to exemplary embodiments, examples of which are illustrated in the accompanying drawings, wherein like reference numerals refer to like elements throughout. In this regard, the present exemplary embodiments may have different forms and should not be construed as being limited to the descriptions set forth herein. Accordingly, the exemplary embodiments are merely described below, by referring to the figures, to explain aspects.

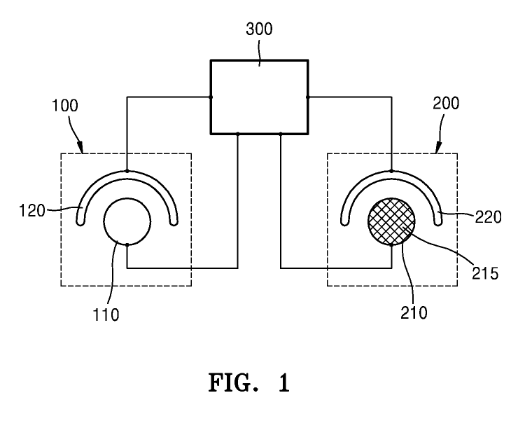

Hereinafter a biosensor according to an exemplary embodiment will be described with reference to FIG. 1. FIG. 1 is a diagram schematically illustrating a biosensor according to an exemplary embodiment.

A first sensor 100 may include a first operation electrode 110 and a first counter electrode 120. The first operation electrode 110 may be spaced apart from the first counter electrode 120. A surface of the first operation electrode 110 may not be coated with a detecting reagent layer including an enzyme. Accordingly, the first sensor 100 may be non-enzymatic. A suitable voltage that may oxidize an analyte in a sample may be applied between the first operation electrode 110 and the first counter electrode 120. In order for a certain amount of sample to simultaneously contact the first operation electrode 110 and the first counter electrode 120, the certain amount of sample may be dropped on the first sensor 100. Then, the first operation electrode 110 may oxidize the analyte in the sample. Oxidization of the analyte may cause generation of an oxidizing current. Accordingly, the first sensor 100 may output the oxidizing current as a first detect signal to a controller 300. The first sensor 100 is non-enzymatic. Thus, even when the concentration of the analyte in the sample is low, the first sensor 100 may output the first detect signal which distinguishably varies according to the concentration of the analyte in the sample.

It is noted that, as the first sensor 100 is non-enzymatic, when a non-analyte that may have a similar oxidation potential as an analyte is present in a sample, not only the analyte but also the non-analyte may be oxidized. In this case, a first detect signal output from the first sensor 100 may have an intensity corresponding to a sum of an amount of oxidized analyte and an amount of oxidized non-analyte. Accordingly, the first sensor 100 may indicate an exaggerated amount of the analyte than the actual amount thereof. Therefore, in the present disclosure, an enzymatic second sensor 200 may be used together in order to monitor if the first sensor 100 indicates an exaggerated amount of the analyte than the actual amount thereof.

The second sensor 200 may include a second operation electrode 210 and a second counter electrode 220. The second operation electrode 210 may be spaced apart from the second counter electrode 220. A surface of the second operation electrode 210 may be coated with a detecting reagent layer 215 including an enzyme. Accordingly, the second sensor 200 may be enzymatic. A suitable voltage that may oxidize an analyte in a sample may be applied between the second operation electrode 210 and the second counter electrode 220. In order for a certain amount of sample to simultaneously contact the second operation electrode 210 and the second counter electrode 220, the certain amount of sample may be dropped on the second sensor 200. Then, an enzyme included in a detecting reagent layer coated on the surface of the second operation electrode 210 may oxidize only the analyte present in the sample. Oxidization of the analyte may cause generation of an oxidizing current. Accordingly, the second sensor 200 may output the oxidizing current as a second detect signal to the controller 300. The second sensor 200 is enzymatic. Thus, when a concentration of an analyte in a sample is low, it may be difficult for the second sensor 200 to output the second detect signal which distinguishably varies according to the concentration in the sample. However, the second detect signal output from the second sensor 200 may have a sufficient intensity to verify whether an analyte is present and whether an amount of an analyte is increased or decreased.

Even when a non-analyte, which may have a similar oxidation potential as an analyte, is present in a sample, the second sensor 200 may oxidize not the non-analyte but only the analyte. Accordingly, the second detect signal output from the second sensor 200 may represent whether the analyte is present and whether the amount of the analyte is increased or decreased.

The controller 300 may receive the first detect signal from the first sensor 100 and the second detect signal from the second sensor 200. In addition, the controller 300 may output a quantitative analysis value corresponding to the first detect signal and a qualitative analysis value corresponding to the second detect signal. The quantitative analysis value corresponding to the first detect signal may have an absolute value of a concentration of an analyte. The qualitative analysis value corresponding to the second detect signal may indicate whether an analyte is present, or whether an amount of an analyte is increased or decreased. For example, the qualitative analysis value corresponding to the second detect signal may be “absent”, “present”, “decreased”, “constant” or “increased”. “Absent” and “present” may be irrelevant to the number of measurement runs. “Decreased”, “constant”, and “increased” are relevant to the previous measurement run.

A user may ignore any quantitative analysis value output from the controller 300 in the case that the controller 300 outputs “absent” as a qualitative analysis value; a user may ignore any constant and increased quantitative analysis value output from the controller 300, in the case that the controller 300 outputs “present” and “decreased” as qualitative analysis values; a user may ignore any decreased and increased quantitative analysis value output from the controller 300, in the case that the controller 300 outputs “present” and “constant” as qualitative analysis values; and a user may ignore any constant and decreased quantitative analysis value output from the controller 300, in the case that the controller 300 outputs “present” and “increased” as qualitative analysis values.

In another embodiment, in the case that a qualitative analysis value is “absent”, the controller 300 may output a quantitative analysis value of “0”; in the case that a qualitative analysis value is “present” and “decreased”, and a quantitative analysis value is constant or increased than that of the previous measurement run, the controller 300 may not output the quantitative analysis value; in the case that a qualitative analysis value is “present” and “constant”, and a quantitative analysis value is decreased or increased than that of the previous measurement run, the controller 300 may not output the quantitative analysis value; and in the case that a qualitative analysis value is “present” and “increased”, and a quantitative analysis value is decreased or constant than that of the previous measurement run, the controller 300 may not output the quantitative analysis value. In these cases, the controller 300 may output information of undetectableness instead of the quantitative analysis value.

In another embodiment, a qualitative analysis value corresponding to a second detect signal may be a ratio of an intensity of the second detect signal obtained from the present measurement run to an intensity of the second detect signal obtained from the previous measurement run. In this case, the controller 300 may output a product between the quantitative analysis value obtained from the previous measurement run and the qualitative analysis value obtained from the present measurement run, as a quantitative analysis value of the present measurement run.

In some embodiments, the first operation electrode 110 may include, for example, platinum (Pt), gold (Au), silver (Ag), iron (Fe), copper (Cu), cobalt (Co), zinc (Zn), titanium (Ti), nickel (Ni), manganese (Mn), an alloy thereof, an oxide thereof, carbon nanotubes, graphene, or a combination thereof.

In some embodiments, a surface of the first operation electrode 110 may be coated with a protective film. The protective film may reinforce the durability, selectivity, or a combination thereof of the first operation electrode 110. The protective film, for example, may include polyvinylidenefluoride (PVDF), chitosan, polyurethane, Nafion, polyethyleneimine (PEI), polyethyleneglycol, or a combination thereof. The protective film may prevent a non-analyte from contacting the first operation electrode 110.

A detecting reagent layer (not shown) coated on a surface of the second operation electrode 210 may include an enzyme. Non-limiting examples of the enzyme may include a glucose oxidase, a glucose dehydrase, a cholesterol oxidase, a cholesterol esterase, a lactate oxidase, an ascorbic acid oxidase, an alcohol oxidase, an alcohol dehydrase, a bilirubin oxidase, or a sugar dehydrase. The detecting reagent layer (not shown) coated on a surface of the second operation electrode 210 may further include a coenzyme. Examples of the coenzyme may include a flavin adenine dinucleotide (FAD) or a nicotinamide adenine dinucleotide (NAD).

In some embodiments, the second sensor 200 may be voltage type. Accordingly, the second detect signal may be a voltage. For example, in the case of voltage type glucose measurement, only a glucose oxidase (GOx) may be used as an enzyme. In the case of glucose oxidation in which oxygen is involved, when a coenzyme is absent, the first electron receptor may be oxygen, forming peroxide. As a result, by measuring the change of pH caused by gluconic acid, which is a resultant of the glucose oxidation, a voltage type second detection signal may be obtained. When only a glucose dehydrase (GDH) is used, detection of gluconic acid may be difficult due to generation of hydrogen ions, and thus, the second sensor 200 may not serve as a voltage-measurement type blood glucose sensor. In the case of a voltage type, measurement of glucose may be possible even when an area of the second operation electrode 210 is small. Accordingly, a biosensor may be miniaturized. On the other hand, in the case of a current type, miniaturization of a biosensor may be difficult since an area of the second operation electrode 210 may be necessarily large.

As described above, according to an exemplary embodiment, a biosensor may have i) sufficient sensitivity allowing quantitative detection of a low concentration of an analyte; and ii) excellent selectivity allowing selective distinction of the present analyte.

It should be understood that exemplary embodiments described herein should be considered in a descriptive sense only and not for purposes of limitation. Descriptions of features or aspects within each exemplary embodiment should typically be considered as available for other similar features or aspects in other exemplary embodiments.

While one or more exemplary embodiments have been described with reference to the figures, it will be understood by those of ordinary skill in the art that various changes in form and details may be made therein without departing from the spirit and scope as defined by the following claims.

What is claimed is:

1. A biosensor comprising:
a first sensor comprising a first operation electrode and a first counter electrode that is spaced apart from the first operation electrode;
a second sensor comprising a second operation electrode and a second counter electrode that is spaced apart from the second operation electrode, wherein a surface of the second operation electrode is coated with a detecting reagent layer comprising an enzyme; and
a controller receives a first detect signal from the first sensor and a second detect signal from the second sensor, wherein the controller outputs a quantitative analysis value corresponding to the first detect signal and a qualitative analysis value corresponding to the second detect signal.

2. The biosensor of claim 1, wherein the quantitative analysis value is an absolute value of a concentration of an analyte.

3. The biosensor of claim 1, wherein the qualitative analysis value is at least one of absent, present, decreased, constant, and increased.

4. The biosensor of claim 3, wherein the controller outputs information of undetectableness as the quantitative analysis value, when at least one of a) the qualitative analysis value is present and decreased, and the quantitative analysis value is constant or increased compared with a previous measurement run, b) the qualitative analysis value is present and constant, and the quantitative analysis value is decreased or increased compared with a previous measurement run, and c) the qualitative analysis value is present and increased, and the quantitative analysis value is decreased or constant compared with a previous measurement run.

5. The biosensor of claim 1, wherein the qualitative analysis value is a ratio of an intensity of the second detect signal obtained from a present measurement run to an intensity of the second detect signal obtained from a previous measurement run.

6. The biosensor of claim 5, wherein the controller outputs a product between the quantitative analysis value obtained from the previous measurement run and the qualitative analysis value obtained from the present measurement run, as a quantitative analysis value of the present measurement run.

7. The biosensor of claim 1, wherein the first operation electrode comprises at least one of platinum (Pt), gold (Au), silver (Ag), iron (Fe), copper (Cu), cobalt (Co), zinc (Zn), titanium (Ti), nickel (Ni), manganese (Mn), an alloy thereof, an oxide thereof, carbon nanotubes, graphene, and a combination thereof.

8. The biosensor of claim 1, wherein a surface of the first operation electrode is coated with a protective film.

9. The biosensor of claim 8, wherein the protective film comprises at least one of polyvinylidenefluoride (PVDF), chitosan, polyurethane, Nafion, polyethyleneimine (PEI), and polyethyleneglycol.

10. The biosensor of claim 1, wherein the enzyme comprises at least one of a glucose oxidase, a glucose dehydrase, a cholesterol oxidase, a cholesterol esterase, a lactate oxidase, an ascorbic acid oxidase, an alcohol oxidase, an alcohol dehydrase, a bilirubin oxidase, and a sugar dehydrase.

11. The biosensor of claim 1, wherein the detecting reagent layer further comprises a coenzyme.

12. The biosensor of claim 11, wherein the coenzyme comprises at least one of a flavin adenine dinucleotide (FAD), and a nicotinamide adenine dinucleotide (NAD).

13. The biosensor of claim 1, wherein the second sensor is voltage type.
